(19) United States
(12) Patent Application Publication
(10) Pub. No.: US 2025/0107959 A1
(43) Pub. Date: Apr. 3, 2025

(54) MASSAGER AND HANDLE FOR A MASSAGER

(71) Applicant: General Physiotherapy II LLC, Earth City, MO (US)

(72) Inventors: Matthew Wootton, Bridgeton, MO (US); Caroline Rausch, Lake in the Hills, IL (US); Zachary Silverstein, St. Louis, MO (US)

(21) Appl. No.: 18/904,686

(22) Filed: Oct. 2, 2024

Related U.S. Application Data
(60) Provisional application No. 63/542,006, filed on Oct. 2, 2023.

(51) Int. Cl. A61H 23/00; A61H 23/02

(52) U.S. Cl. CPC A61H 23/006; A61H 23/0263; A61H 2201/0153; A61H 2201/1215

(57) ABSTRACT

A handle structure for a hand-held massager, and the massager itself, which utilizes what is referred to as a “Z”-shape. Specifically, the system provides for a generally linear main body with the massage head generally arranged at a generally right angle to the main body at or toward one of the two ends and will typically be close to the main body with little lateral extension except the physical head itself. At the opposing end, there will be a tail which acts as a secondary handle. The tail may serve to hold a removable battery pack or an internal battery or transformer and will also extend generally perpendicularly from the main body in the generally opposing direction to the massage head.

### CROSS-REFERENCE TO RELATED APPLICATION(S)

This application claims the benefit of United States Provisional Patent Application Ser. Number: 63/542,006, filed on Oct. 2, 2023, the entire disclosure of which is herein incorporated by reference.

### BACKGROUND

### 1. Field of the Invention

This disclosure is related to the field of massage devices and particularly to handles or housings for massage devices.

### 2. Description of the Related Art

The therapeutic use of massage is ancient. The concept of using externally applied rhythmic or other motion to stimulate or relax the muscles of the human body has been used to relieve pain, heal injury or deal with the symptoms of illness for thousands of years. It is, in fact, a practice that many humans do almost instinctually. Humans will often massage or rub sore muscles or other areas of their own bodies which hurt. The background of therapeutic massage was originally developed around the concept of rebalancing spiritual elements of the body through external force to resolve issues with pain or illness. However, even in ancient Greece, athletes recognized that muscle massage could assist in preparation for activity, or to better recover from it, by improving muscle function.

In the modern world, massage therapy is a well-studied and recognized therapeutic

technique used in a wide variety of different ways. Massage is often used to warm up and stretch muscles prior to physical exertion, to relax muscles after physical exertion, and to assist damaged elements of the body to recover from traumatic injury. In effect, massage is often used to externally alter muscle fibers whenever that is beneficial, and massage is often associated with muscle or similar tissue stimulation in the extremities or back. However, that is not all massage is commonly used for. Massage can also be used to help with other body issues not directly related to musculature. For example, massage is often used to breakup and clear the lungs of bronchial secretions or other congestive material, to encourage or bypass pumping of the heart, as well as to stimulate activity, or simply provide pleasure.

While therapeutic massage can be highly beneficial, providing it can be difficult. There are traditionally a number of different types of massage which are used. These can range from Effleurage, which uses long, gliding, typically circular strokes; to Petrissage, a technique that is rhythmic and may include kneading, skin rolling, lifting or a push-pull movement; to Tapemotement, which is a percussive motion that typically involves tapping or similar movements. Vibrational massage, where part of the body is gripped and shaken quickly is also used in other circumstances. These different types of massage require different training to learn to perform effectively and safely and, thus, effective therapeutic massage often has to be provided by a trained professional masseuse to be safe and effective.

In order to allow massage to be provided easier, and without the need to have a masseuse be present, machines that produce massaging motions have been developed and can be used for self-care. Such machines also can assist professionals be providing massage motions which are difficult, tiring, or even impossible to perform with the hands directly. These machines often can provide two different types of massage motion. The first is vibratory or oscillatory motion and the second provides more percussive motion. While both types of motion are generally similar and have substantial overlap, they can typically differ in simply how the motion of the machine is applied to the human body and how intense the motion is in certain directions.

Massage machines are ultimately controlled by some form of motor and most motors produce rotational motion where a rotor is rotated about a central axis via a stator through the application of electrical pulses through the stator. This type of motion is smooth and continuous and is not terribly useful for massage activity directly. However, by attaching an eccentric mass to the rotor, the subsequent rotation of the rotor will cause the mass to effectively oscillate around the rotor and the inertia imparted by the moving mass will generally cause the motor, and thus the massager, to shake. This vibration can then be used to move a shaped head which can be placed against the body. The nature of the vibration, the direction of the mass's principle rotation relative to the body, and the shape of the head can then be selected to produce different massaging motions.

Assuming the rotor can be held completely still, the mass's oscillation will be generally within a plane perpendicular to the axis of rotation and will be circular around the point of rotation. However, when this motion is viewed within a plane parallel to the axis of rotation, the motion of the eccentric mass will become generally sinusoidal. This difference in motion can be used to provide for different massage effects based on the positioning of an attached massage head, and the human body surface being acted on, relative to the axis of rotation of the eccentric mass. In effect, the rotation of the eccentric mass causes the massaging device to move, vibrate, shake, and/or percuss in a certain way based on the relative positioning of the components.

Should the rotating mass be placed on the body with the plane of rotation being directed into the body, the constantly changing radius caused by the eccentric mass moving appears generally sinusoidal and will typically cause the mass to rhythmically percuss into the body. If the mass is relatively small, and often if the rotation is faster, this may be more of a vibrational motion. Changing the plane of rotation can alter this percussive motion and produce a more sliding or oscillatory motion. Percussive and vibrational motion are commonly directed into the body, and a percussive massager tends to result in a tapping or hitting motion depending on the speed of rotation and the mass of the eccentric weight which can be more akin to Tapemotement massage, or can be its own thing entirely. Percussive motions can also be provided through other forms of motor movement, such as through the use of a crankshaft, as many type of motors or drive mechanisms are designed to produce generally linear motion which can be directed into the body. Vibrational or oscillatory motion also tends to be directed at least somewhat into the body, but the depth of movement is often shorter and less intense than percussive motion. The vibration may also be faster than the percussive motion. This can provide a motion more akin to shaking as opposed to true percussion.

Percussive and vibrational motion have proven particularly desirable in conjunction with athletic performance massage and so-called “massage guns,” which provide such massage, are typically designed to enable the massage to be provided both by an external individual, such as a trainer or teammate, or by the individual to themselves. In order to be easy to use, a couple of basics of the self-application of massage should be recognized.

Generally, massage is carried out so that the percussive up and down motion component of the massage is directed directly into the body and particularly into large muscles which are commonly worked in exercise or other athletic training. These are often the muscles in the upper legs (thighs), upper arms (biceps), or into large core muscles in the torso including the back. Because the motion is often supplied by a rotating eccentric mass, the plane of rotation of the mass will typically be generally perpendicular to the body surface. Further, any massage device producing vibration will have a tendency to shake or move itself in addition to, or more accurately instead of, vibrating the body surface it is in contact with. Specifically, the rotation of the eccentric mass will serve to not only percuss the head, but to shake the device as a whole in a direction corresponding with the location of the mass. Should the device be completely unsupported, it will often be the case that the device will simply shake as opposed to providing the desired motion. However, the stronger the device is supported and the more force used to press the device into the body surface, typically the more of the motion that is transferred to the body. Thus, the ability to better control the force pushing the massager into the body is highly desirable as it gives a massager flexibility in use. While in some cases, the force of gravity on the mass of the device can be used to provide sufficient force to push the head against the body, in most cases, the device needs to be held against the body (and the target muscle) by the hands and, thus, the ability to better manipulate the massage head with the hands is desirable. For these reasons, the shape of the massager and the location where it can be, and is designed to be, held can dramatically alter the usability of the device.

Traditionally, a massage gun will be designed to be held in the hand and the hand can be used to press the head of the massage gun into the body. The muscles of the hand and arm supporting the massage gun, and in extreme cases, the user's mass, can be used to inhibit motion of the massage gun. This serves to transfer the motion of the massage head into the target muscle with differing force depending on the strength of the user, the angle of the gun relative to the target structure, the positioning of the massage gun relative to the structures of the user's arm and hand, and the grip that the user's hand can have on the massage gun.

To both allow for positioning of the massage head against a target muscle, and to provide for sufficient force to be provided to the gun, massage guns have traditionally had two fairly particular shapes. The first shape is to simply be linear. In a linear device, the major components are arranged in line so that the device resembles a rod or shaft with the massage head extending from one end. The head will then typically percuss along the major axis of the device or may vibrate in a perpendicular motion.

To use the device, the user grasps the device in what is often referred to as a cylindrical grip or power grip. This involves placing the palm against the exterior of the device and wrapping the fingers around it in a first direction and the thumb around the device in the other direction. The thumb will generally touch the index finger and/or middle finger if the diameter is sufficiently small so that the main axis of the device runs across the palm of the hand and through the circle formed by the thumb and index/middle finger. The end having the head is then placed against the body and the strength of the user's grip (the force they supply from closing their fist) is used to hold the device. Their arm muscles, and particularly forearm muscles, are used to keep their hand from moving.

While this can be quite effective, the motion of the head being along the major axis will actually place the motion of the device during percussion motion generally perpendicular to the major axis of the forearm. Thus, the muscle of the forearm is not at its strongest to resist this motion. Strength can be enhanced by using the user's mass or other hand to push against the end of the linear device opposing the head or by placing a hand over the end using a generally open spherical grip. While this lends strength, it can be uncomfortable, particularly when used on oneself.

A spherical grip is the grip used to grasp a ball, as opposed to a cylinder, and instead of the joints of the fingers generally being aligned with each other and adjacent as in a cylindrical grip, the fingers are commonly spread out and while the specific bend of each finger may be similar or not, the major joints are generally not aligned but are positioned on a simple or even complex curve. A spherical grip is often more akin to presenting the hand as a talon or claw type arrangement as opposed to a cylindrical grip where the hand essentially forms a tube. The thumb is also not positioned to form a circle with the index/middle finger but is extended more to the side of the palm.

The power or cylindrical grip is actually a very common grip used by humans in tool manipulation because it allows a user to have a very rigid and solid grasp of an object while a spherical grip often provides for much less strength to keep the object from moving or slipping from the grip. A spherical grip can, however, be used strongly to “push” an object when the forearm is aligned with the palm and the bicep is used to force the entire forearm toward the palm and can provide for improved manipulation of the object in a variety of planes of movement. When a spherical grip is used to push, the bone structure of the forearm acts to enhance the muscle movement and resist movement of the object toward the palm. However, pulling (moving the object toward the palm) has very little strength since the finger's connection to the object is the only connection, is done along the line of the finger, and is generally parallel to its skeletal structure. This is weaker as there is no bone structure to transmit the force.

A cylindrical grip typically allows the user to both push and pull on the structure utilizing their arm muscles (as opposed to those of their fingers). The fingers, instead, are simply used to connect the arm muscle to the object and support it. In a push motion, the forearm is still aligned and the strength is similar to a spherical grip. However, in a pulling motion, the wrapping position of the fingers about the object allow the use of their internal bone structure, and the force of the fist being closed which is perpendicular to their length as opposed to parallel to it, to be used to resist opposing motion of the device.

Because the cylindrical grip can be so much stronger in the pull direction, a percussive massager will often utilize a “pistol grip” to utilize the device. In a pistol grip device, the motor is typically positioned in line with the massage head and then a handle, which will often include the battery in a rechargeable or cordless device, is positioned as the leg of a “T” relative to the motor. This allows the hand to grip the leg of the “T,” which is the handle and is often specifically sized, shaped, and contoured to fit the hand, with the motor and head resting on the fist above the thumb. Pistol grips are well-known to supply significant power and control from the user to the device as the grip is very easy for the human operator to obtain and allows a lot of strength of the user to be brought to bear. In particular, the forearm is typically aligned with the percussive motion of the head while the handle is perpendicular to both which allows for the forearm to act as a brace for motion of the device.

While these are both effective designs for massagers, they have also proven to be problematic in some regards. A pistol grip device in particular is often not readily used on oneself and cannot be used in confined spaces because the significant distance that the head is from the hand can require the user to contort their hand into a generally backwards angle to aim the device at their body and the device generally cannot readily fit in confined spaces such as to massage the upper legs or under the arms. Further, because the massage head is typically extended from the user's hand, it can be very hard to get the device around the user's back. Linear devices can resolve some of these concerns, but with all the components in line, linear grip devices are often quite long (even if narrow) which can make it even more difficult to align the device generally perpendicular to the body surface in a confined space and even if it can be aligned, it may be hard to strongly grip the device and hold it in position.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein is a handle structure for a hand-held massager, and the massager itself, which utilizes what is referred to as a “Z”-shape. Specifically, the system provides for a generally linear main body which also serves to act as the primary handle. The massage head will generally be arranged at a generally right angle to the main body at or toward one of the two ends and will typically be close to the main body with little lateral extension except the physical head itself. At the opposing end, there will be a tail which acts as a secondary handle, which will often serve to hold a removable battery pack or an internal battery or transformer. The secondary handle will also typically be arranged to extend generally perpendicularly from the main body but will typically do so in the generally opposing direction to the massage head (that is, extending from the main body in a direction essentially 180 degrees from the extension of the head). The secondary handle and massage head will typically be generally co-planar but that is not required.

There is described herein, in an embodiment, a handheld massager comprising: a generally cylindrical main body having a major axis and two opposing ends with a motor mounted therein; a head shell attached to said main body at a first of said two ends and including a head mount; a massage head mounted to said head mount; a secondary handle attached to said main body at a second of said two ends; and a battery electrically connected to said motor and mounted within said secondary handle, said secondary handle and battery combination extending along a secondary main axis; wherein said motor drives said massage head to percuss along a main axis generally parallel to said secondary main axis and non-parallel to said major axis.

In an embodiment of the massager, the head shell extends further along said major axis than said head mount extends along said main axis.

In an embodiment of the massager, the main body extends further along said major axis than said secondary handle extends along said secondary main axis.

In an embodiment of the massager, the motor drives said massage head via rotation of an eccentric weight about said major axis.

In an embodiment of the massager, the eccentric weight rotates in a plane generally parallel to said main axis.

In an embodiment of the massager, the battery includes a portion partially exposed from said secondary handle.

In an embodiment of the massager, the battery includes a cover on said partially exposed portion.

There is also described herein, in an embodiment, a handheld massager comprising: a generally cylindrical main body having a major axis and two opposing ends with a motor mounted therein; a head shell attached to said main body at a first of said two ends and including a head mount; a massage head mounted to said head mount; a secondary handle attached to said main body at a second of said two ends; and a battery electrically connected to said motor and mounted partially within said secondary handle, said secondary handle and battery combination extending along a secondary main axis generally perpendicular to said major axis; wherein said motor drives said massage head to percuss along a main axis generally perpendicular to said major axis.

In an embodiment of the massager, the head shell extends further along said major axis than said head mount extends along said main axis.

In an embodiment of the massager, the main body extends further along said major axis than said secondary handle extends along said secondary main axis.

In an embodiment of the massager, the motor drives said massage head via rotation of an eccentric weight about said major axis.

In an embodiment of the massager, the eccentric weight rotates in a plane generally parallel to said main axis.

In an embodiment of the massager, the battery includes a portion partially exposed from said secondary handle.

In an embodiment of the massager, the battery includes a cover on said partially exposed portion.

There is also described herein, in an embodiment, a handle for a handheld massager, the handle comprising: a generally cylindrical main body having a major axis and two opposing ends; a head shell attached to said main body at a first of said two ends and including a head mount; and a secondary handle attached to said main body at a second of said two ends, said secondary handle extending along a secondary main axis; wherein said head mount extends along a main axis generally parallel to said secondary main axis and non-parallel to said major axis.

### BRIEF DESCRIPTION OF THE DRAWINGS

FIG. 1 provides a side view of an embodiment of the handle.

FIG. 2 provides a side view of the embodiment of the handle of FIG. 1 with a massage head and battery in place to form an embodiment of a hand-held massager.

FIG. 3 provides a cut-away view of FIG. 1 illustrating an embodiment showing the location of various internal components.

FIG. 4 provides a cut-away view of the embodiment of FIG. 2.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matters contained in the description or shown in the accompanying drawings shall be interpreted as illustrative and not in a limiting sense.

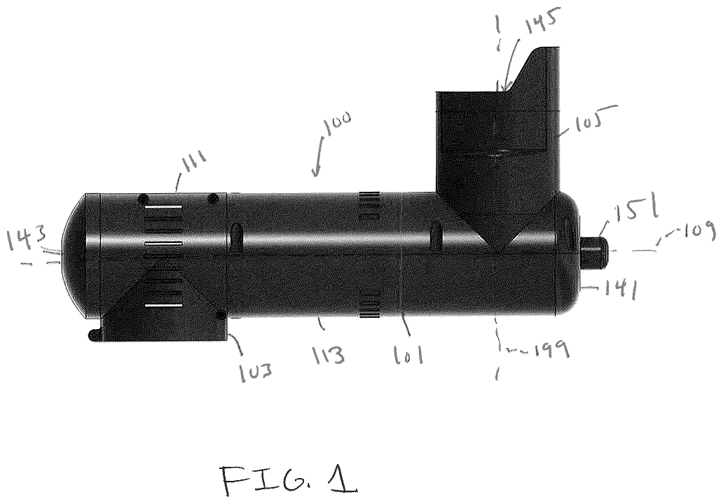

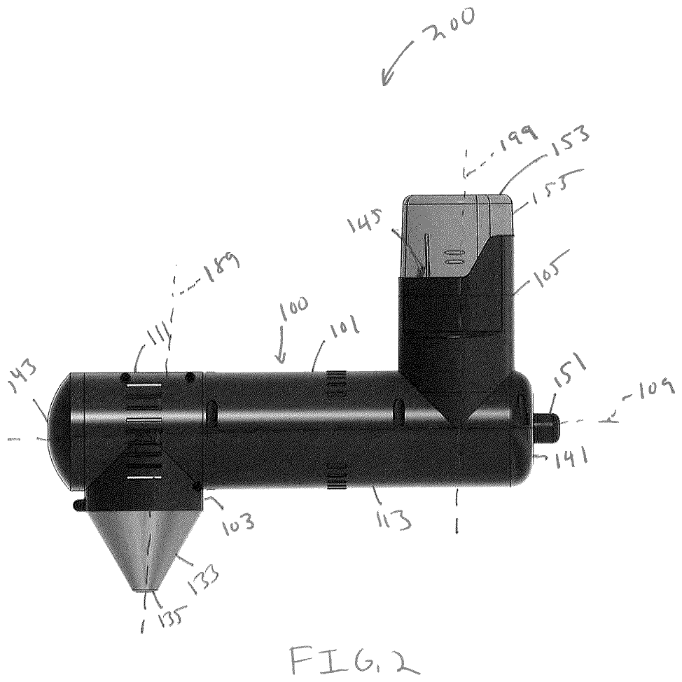

FIG. 1 shows an embodiment of a handle (100) for a mechanical massager (200) shown with a massage head and battery attached in FIG. 2. The handle (100), generally comprises three major sections. The main body (101) will be generally linear and will typically serve to house the motor (301) and the counter weight mechanism (303) and may also have positioned thereon controls (151). The main body will typically be generally cylindrical about a main axis (109) and will usually be sized and shaped to efficiently be gripped in a cylindrical grip by a human hand. The main body (101) may be monolithic, or may be formed of multiple component pieces. In the depicted embodiment, the main body (101) has attached thereto a head shell (111) which serves to house the counter-weight mechanism (303). The combination of head shell (111) and main body (101) together form a single generally linear structure arranged along the main axis (109).

Toward a first end (143) of the head shell (111), which will usually be closed, there is positioned a head mount (103) which may serve to mount the massage head (133). In the depicted embodiment, the head mount (103) is on a side of the head shell (111) which will generally be preferred, but is by no means required and in an alternative the head mount may extend from the end of the head shell (111). The head mount (103) of the depicted embodiment is positioned so as to position the head (133) to percuss in a generally perpendicular direction to the major axis (109) of the main body (101) and specifically along the main axis (189). While this is typically preferred, the head mount (103) and main axis (189) may be arranged at an angle other than 90 degrees from the major axis (109) so as to be at any non-parallel angle with the major axis (109). The end (135) of the massager (133) is the working end of the device (200) and would be intended to be placed against the body. The head mount (103), in the depicted embodiment, is designed to not extend more than necessary from the head shell (111) with the idea of placing the working end (135) as close to the axis (109) as it can be given the mechanical need to interconnect the head (133) to the other components and have it move as desired. In the depicted embodiment, the head (133) is designed to be repeatedly removable and reattachable to the head mount (103) which allows for interchange between different heads (133) and/or replacement of a worn out head (133).

Toward the opposing end (141) of the main body (101) there is positioned a tail which is referred to herein as the secondary handle (105). The secondary handle (105) will typically extend generally perpendicularly from the major axis (109) of the main body (101) but this is by no means required and it may extend at other angles. The secondary handle (105) will also typically be generally cylindrical around a secondary main axis (199) but other shapes may be used. The secondary handle (105) will also typically be sized and shaped to be easily gripped in a cylindrical grip by a human hand.

In the depicted embodiment, the secondary main axis (199) of the secondary handle (105) is generally parallel to the main axis (189) of the head (133) and this is typically a preferred arrangement. It may be the arrangement if both the secondary main axis (199) and the main axis (189) are generally perpendicular to the major axis (109) of the main body (101), or if they are not and are both at any other non-parallel (and typically matching) angle with the major axis (109). However, in alternative embodiments, the two need not be generally parallel and they may be arranged so as to be oriented at different relative angles to each other in any plane. For example, in an embodiment, the secondary handle (155) may be tilted relative to the head in the plane of the paper which means it does not extend generally perpendicular from the major axis (109) of the main body (101) while the massage head (133) may still be arranged generally perpendicularly. In a still further embodiment, the secondary handle (105) may still be generally perpendicular to the major axis (109) of the main body (101) but will extend directly toward or away from the viewer of FIG. 2 which would make the major axis (199) of the secondary handle (155) generally perpendicular to both the major axis (109) of the main body and the major axis (189) of the head (133).

In the depicted embodiment, the secondary handle (105) is quite short with a length substantially less than the main body (101). This is because, in the depicted embodiment, the secondary handle (105) may be designed to act as a battery mount and when a removable battery (155) is inserted it extends from an open end (145) of the secondary handle (105) and the battery (155) forms part of the structure gripped by a human user when gripping the secondary handle (105). This is by no means required, however, and the battery (155) may be positioned entirely internal to the secondary handle (105) or elsewhere in the handle (100) which placement could, along with other considerations, alter the length of the secondary handle (105).

In a still further alternative embodiment, the secondary handle (105) may not house a battery (155) at all but may house a plug for an AC power cable and an integrated AC/DC converter, or may be able to be connected to an external DC power source. In the depicted embodiment of FIG. 2, the battery (155) may actually include a cover (153) which may be separable from the battery (155) without damage or may be attached to the battery (155) as part of its housing so as to cover the portion of the battery (155) which would extend from the secondary handle (105) to provide a uniform diameter to the secondary handle (105).

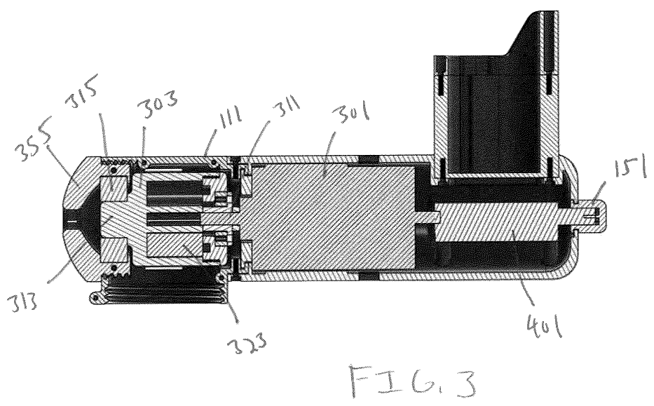

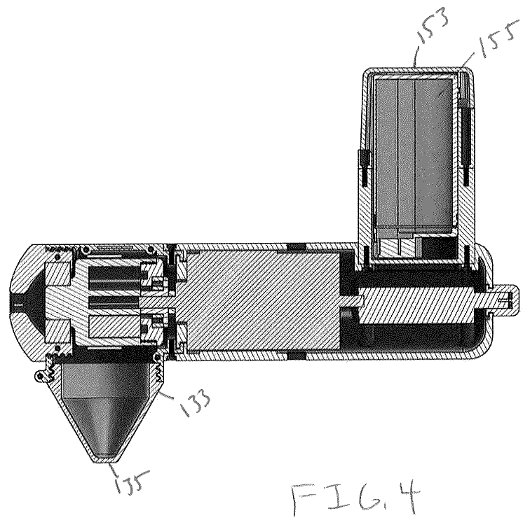

FIGS. 3 and 4 provide for cutaway views of the handle (100) and device (200) to show an embodiment of possible placement of mechanical structures to drive the massager. FIG. 3 corresponds to FIG. 1 while FIG. 4 corresponds to FIG. 2. The major components of the massager (200) include the motor (301) which is typically a DC electric motor producing rotation of a rotor (311). The rotor (311) is then connected to a counter-weight mechanism (303) which typically comprises a housing (313) that is attached to the rotor (311). The housing (313) typically has a counter-weight (323) positioned off-center. Rotation of the counter-weight (323) will produce movement perpendicular to the rotational axis of the rotor (311) which will cause the massage head (133) to percuss along the head's (133) major axis (189). The counterweight mechanism (303) is supported by bearings (315) which are in turn supported by bearing housing (355).

To run the motor (301), the motor (305) is typically electrically connected to a motor controller (401). Alternatively, the motor controller (401) may be a purely mechanical construct with all electrical control included in the motor (301) and the motor controller (401) acting simply to alter those electrical components mechanically. The motor controller (401) is typically controlled by controls (151) which may be any type of controls. In an embodiment, they may comprise buttons, switches, or similar binary type controls which are either on or off. In an alternative embodiment, the controls (151) may comprise a dial which could act as a variable continuous control where the turning of the dial could, for example, continuously alter the speed of the motor (301) and could also serve to disconnect the motor (301) from the battery (155) to stop the motor (301) motion.

The battery (155) is typically electrically connected to the motor (301) via the motor control (401) and the motor control (401) may obtain power from the battery (155) should it need it. The motor control (401) will also typically serve to connect and disconnect the battery (155) from the motor (301) when the battery (155) is positioned in the secondary handle (105) to turn the massager (200) on and off.

The Z-shape of the handle (100) provides for a number of benefits in maneuvering the massager (200) relative to the body and for providing percussive, vibratory, or other (depending on the head (133) used) massage to various parts of the human body and is primarily designed to be used by a user on themselves, but that is not required. In the first instance, as can be best seen in FIG. 2, the handle (100) is relatively linear at least toward the first end (143). This allows the head (133) to be positioned in a relatively narrow space as only the head length and the diameter of the main body (101) needs to be able to access any confined space to massage the area. This can be particularly useful in massaging inner muscles of the arms or legs as the massager is not particularly bulky or large around the head (133) as compared to prior designs.

Still further, the handle (100) may be gripped at a number of points depending on space and accessibility as well as the desired force to be applied to the head (133). In a first mode of operation, the user would typically grip the main body (101) in a cylindrical grip. This allows the user to securely hold the device (200) and easily maneuver the head (133) where desired. Further, as their hand is relatively near the head (133), and the main axis (189) of the head (133) can be aligned parallel with the main axis of a user's forearm, the hand can usually supply substantial pressure to the head (133) using the forearm. If more force or finer control is necessary, the user can usually grasp the head shell (111) directly. This is often more of a spherical grip and it can serve to position the main axis (189) of the head (133) within the cylinder generally indicative of the user's forearm which effectively makes the axis (189) co-linear with the user's forearm). This allows for the entirety of the forearm's bone structure to be aligned with the direction of percussion and allows for the user to apply substantial force to the head (133) quite easily. Further, as the hand is so close to the head (133), it can allow for fine control of positioning of the head (133). This later option can be particularly useful if the massager is used on oneself.

Alternatively, if space around the head (133) is crowded, the user may grasp the secondary handle (105) to hold the device. While this typically does not allow as much force to be brought to bear by the arm to the head (133), it places the hand completely out of the way of the head (133) allowing the head (133) to access smaller spaces quite easily. Specifically, this allows the user to hold the device (200) with a reverse “T” grip should the massage head be positioned below the users fist (the orientation of FIG. 1) or to use a more traditional “T” grip should the user wish to aim the head (133) upwards.

This last orientation is one not commonly seen for personal massagers, but can provide for a number of benefits as it allows for the device (200) to effectively turn corners. Specifically, it can be helpful to utilize such a grip to reach areas on the backside of the body. This can be particularly useful on the lower back, the shoulders, or the backside of the legs.

In a still further mode of operation, a user may control the device (200) with both their hands. In this case, the user may place one hand toward the head (133) on the head shell (111) and one hand on the main body (101). This can provide for substantial force to the head (133) and also allows for easy pivoting of the head (133) relative to the body in any plane.

Alternatively, one can place one hand on the head shell (111) and one on the secondary handle (105). In this case, the user's hands are effectively toward the two ends of the main body (101) and this will give the user substantial control of the device. Specifically, the primary structure and mass of the device is either within or between their hands making it easy to hold, manipulate and/or apply torque. This arrangement may be particularly useful if using the massager on another person. In a still further option, the user may place one hand on the secondary handle (105) with a second on the main body (101), or also on the secondary handle (105). This grants a user a stronger grip on the tail end of the device (200), while still allowing the head (133) to be placed in a relatively small space as the hands are removed from the head shell (111) area completely.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “spherical” are purely geometric constructs and no real-world component or relationship is truly “spherical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A handheld massager comprising:
a generally cylindrical main body having a major axis and two opposing ends with a motor mounted therein;
a head shell attached to said main body at a first of said two ends and including a head mount;
a massage head mounted to said head mount;
a secondary handle attached to said main body at a second of said two ends; and
a battery electrically connected to said motor and mounted within said secondary handle,
said secondary handle and battery combination extending along a secondary main axis;
wherein said motor drives said massage head to percuss along a main axis generally parallel to said secondary main axis and non-parallel to said major axis.

2. The massager of claim 1 wherein said head shell extends further along said major axis than said head mount extends along said main axis.

3. The massager of claim 2, wherein said main body extends further along said major axis than said secondary handle extends along said secondary main axis.

4. The massager of claim 3 wherein said motor drives said massage head via rotation of an eccentric weight about said major axis.

5. The massager of claim 4 wherein said eccentric weight rotates in a plane generally parallel to said main axis.

6. The massager of claim 1 wherein said battery includes a portion partially exposed from said secondary handle.

7. The massager of claim 6 wherein said battery includes a cover on said partially exposed portion.

8. The massager of claim 1, wherein said main body extends further along said major axis than said secondary handle extends along said secondary main axis.

9. The massager of claim 1 wherein said motor drives said massage head via rotation of an eccentric weight about said major axis.

10. The massager of claim 1 wherein said eccentric weight rotates in a plane generally parallel to said main axis.

11. A handheld massager comprising:
a generally cylindrical main body having a major axis and two opposing ends with a motor mounted therein;
a head shell attached to said main body at a first of said two ends and including a head mount;
a massage head mounted to said head mount;
a secondary handle attached to said main body at a second of said two ends; and
a battery electrically connected to said motor and mounted partially within said secondary handle, said secondary handle and battery combination extending along a secondary main axis generally perpendicular to said major axis;
wherein said motor drives said massage head to percuss along a main axis generally perpendicular to said major axis.

12. The massager of claim 11 wherein said head shell extends further along said major axis than said head mount extends along said main axis.

13. The massager of claim 12, wherein said main body extends further along said major axis than said secondary handle extends along said secondary main axis.

14. The massager of claim 13 wherein said motor drives said massage head via rotation of an eccentric weight about said major axis.

15. The massager of claim 14 wherein said eccentric weight rotates in a plane generally parallel to said main axis.

16. The massager of claim 11 wherein said battery includes a portion partially exposed from said secondary handle.

17. The massager of claim 16 wherein said battery includes a cover on said partially exposed portion.

18. The massager of claim 11, wherein said main body extends further along said major axis than said secondary handle extends along said secondary main axis.

19. The massager of claim 11 wherein said motor drives said massage head via rotation of an eccentric weight about said major axis.

20. A handle for a handheld massager, the handle comprising:
a generally cylindrical main body having a major axis and two opposing ends;
a head shell attached to said main body at a first of said two ends and including a head mount; and
a secondary handle attached to said main body at a second of said two ends, said
secondary handle extending along a secondary main axis;
wherein said head mount extends along a main axis generally parallel to said secondary main axis and non-parallel to said major axis.
